(19) United States
(12) Patent Application Publication
(10) Pub. No.: US 2008/0282659 A1
(43) Pub. Date: Nov. 20, 2008

(54) Cutting Head for Brush-Cutter, Edge-Trimmer or the Like Provided with Improved Means for Locking a Cutting Wire

(76) Inventor: Emmanuel Legrand, Villeneuve (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/585,164

(22) PCT Filed: Jan. 9, 2004
(86) PCT No.: PCT/FR04/00031

§ 371 Date: Jun. 30, 2006

(51) Int. Cl. A01D 34/416

(52) U.S. Cl. 56/12.7; 30/276

(57) ABSTRACT

The invention concerns a cutting head for bush cutter, hedge cutter or the like comprising a channel for a cutting wire and a mobile element for locking the wire. The invention is characterized in that the locking element comprises a slide adapted to move linearly in a guide which intersects the wire channel and is subjected to a force, le slide and the wire passage proximate the guide having working surfaces adapted to lock the wire by shearing effect. Thus the wire is better retained and the locking efficiency is substantially independent of the wire section (both in terms of shape and size).

The present invention relates generally to the field of devices for cutting plants, such as brush-cutters, edge-trimmers, etc.

In this type of device, one or more cutting wires, either paid out from a reserve gradually as wear takes place, or in the form of individual strands or sections replaced as they wear, must be firmly locked relative to the rotary cutting head on which they are mounted.

In this respect, a certain number of techniques are known for locking the wire.

One of these techniques uses a movable locking element of the cam type, which is acted upon by a spring and/or by the centrifugal force generated during the rotation of the head to exert a pressure on the wire, a bearing counter-wall being provided opposite the locking element to locally trap the wire between the element and the bearing wall. Documents U.S. Pat. No. 4,301,642, U.S. Pat. No. 4,335,510 and EP-A-0 824 854 give examples of these techniques.

To improve the locking effect, it is also a known practice to provide on the locking element a series of teeth capable of a better anchoring with the material (usually a polyamide) of the wire.

Such known arrangements for locking the wire however have certain disadvantages. The first of them is that they require precise and sometimes complicated arrangements in the cutting head (pivot shaft, spring abutments or wedges, etc.) which consequently is more costly to manufacture whether it be by molding, by machining, etc. The second is that the toothed cam is a metal piece that must be precision machined and made of a mechanical alloy of sufficient strength and rigidity and that is therefore also costly.

In addition, the assembly of the unit is tricky which further affects the production cost.

Finally, the locking devices with cam are usually ill-suited to locking wires of different sizes and/or shapes.

The present invention aims to alleviate these disadvantages in the prior art and to propose a wire locking that is improved in terms mainly of cost and simplicity, without sacrificing the effectiveness of the locking.

Another object of the present invention is to allow, if desired, the locking mechanism to be adapted to wires of very varied sizes and shapes.

Accordingly, the invention proposes a cutting head for a brush-cutter, edge-trimmer or similar, comprising a passageway for a cutting wire and a movable element for locking the wire, characterized in that the locking element comprises a slide which is capable of moving linearly in a guide that intersects the wire passageway and which is subjected to a force, the slide and the wire passageway in the vicinity of the guide having working surfaces capable of locking the wire by shearing effect.

Certain preferred, but nonlimiting, aspects of this cutting head are as follows:
said force is a centrifugal force generated by the rotation of the head.
the slide is acted upon by a spring.
the spring acts in the same direction as the centrifugal force.
the cutting head comprises two passageways for two sections of cutting wire.
the wire passageway or each wire passageway opens onto the outside of the head at its two ends, so as to receive a section of cutting wire whose two terminal lengths operate.
the cutting head comprises a common slide capable of locking the two sections of cutting wire.
the cutting head comprises two slides capable of locking respectively the two sections of wire.
the two slides are capable of moving in opposite directions along a diameter of the head.
the two wire passageways are parallel with one another.
the two ends of the two wire passageways define four wire outlets mutually spaced at approximately 90° in the peripheral direction of the head.
the section of the wire passageway or of each wire passageway is chosen from the circular, oblong or polygonal shapes.
the section of the wire passageway or of each wire passageway has a flattened diamond shape.
the working surface of the slide belongs to a through wire passageway formed in the slide.
the through wire passageway formed in the slide has the same cross section as the corresponding wire passageway formed in the cutting head.
the through wire passageway formed in the slide has a cross section different from that of the corresponding wire passageway formed in the cutting head.
the working surface of the slide is formed on a profiled working region.
the working surface of the slide is oriented obliquely relative to the direction of movement of the slide.
the slide or each slide comprises an actuation portion that can be accessed from the outside of the head and that makes it possible to position said slide so that it does not form an obstacle to the engagement of a section of cutting wire in the corresponding wire passageway formed in the head.
said actuation portion is, in the radial direction, set back relative to the periphery of the cutting head.

The invention also proposes a cutting device such as a brush-cutter, edge-trimmer or the like, characterized in that it comprises a motor capable of rotating a cutting head as defined hereinabove.

Other aspects, objects and advantages of the present invention will become clearer on reading the following detailed description of the preferred embodiments of the latter, given as a nonlimiting example and made with reference to the appended drawings, in which:

FIG. 1 illustrates schematically in elevation three components participating in a wire locking device of a plant cutting head according to the invention,

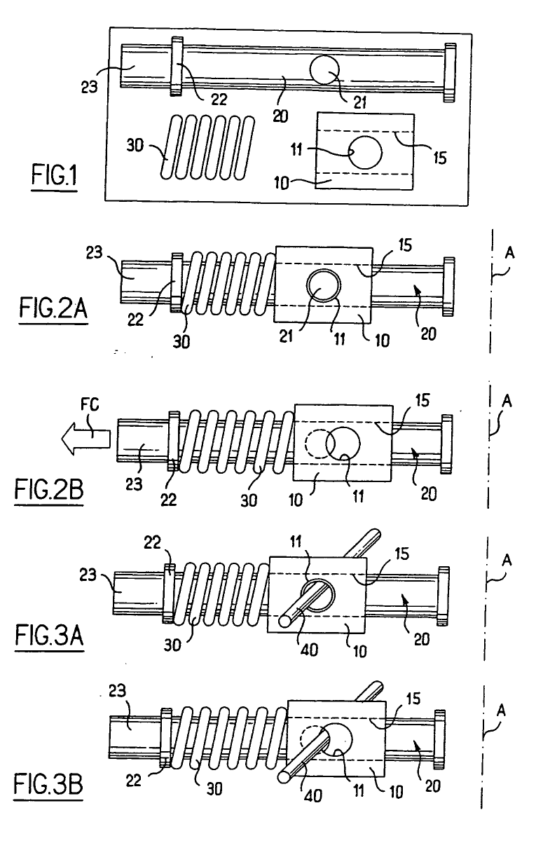

FIGS. 2A and 2B illustrate the behavior of these three components in two different positions,

FIGS. 3A and 3B are views similar to FIGS. 2A and 2B with the presence of a cutting wire,

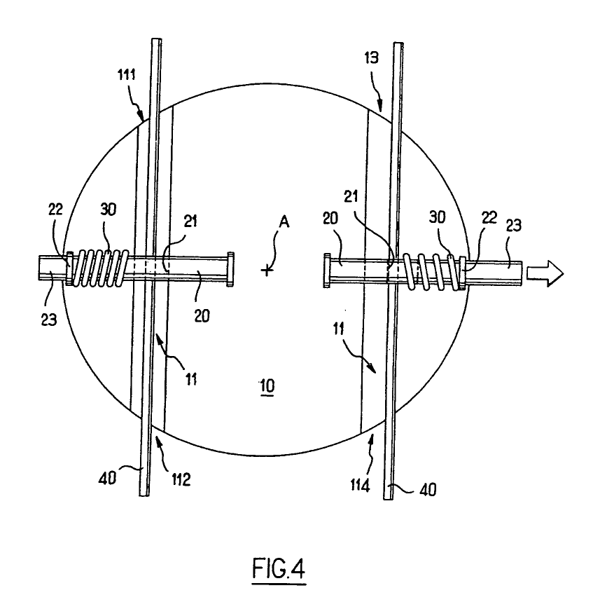

FIG. 4 is a schematic view partially in horizontal section and partially from above of a cutting head comprising two wire locking devices as described hereinabove,

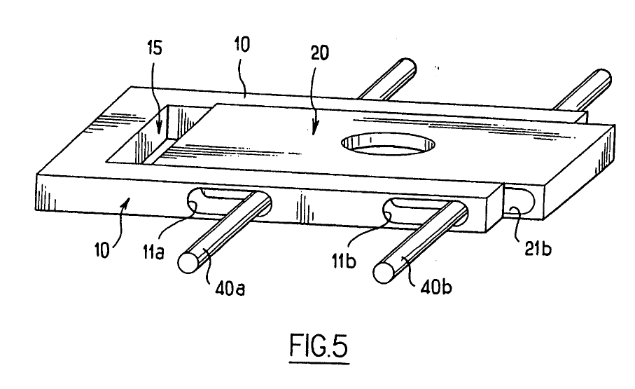

FIG. 5 is a schematic view in perspective of a locking device for two cutting wires,

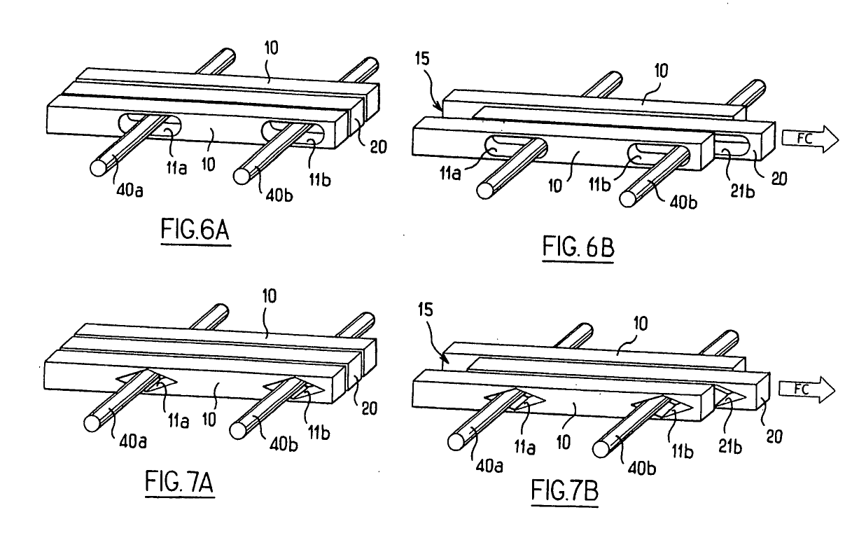

FIGS. 6A and 6B illustrate the behavior of a device similar to that of FIG. 5, in two different positions,

FIGS. 7A and 7B illustrate a variant embodiment of the device of FIGS. 6A and 6B, in corresponding positions,

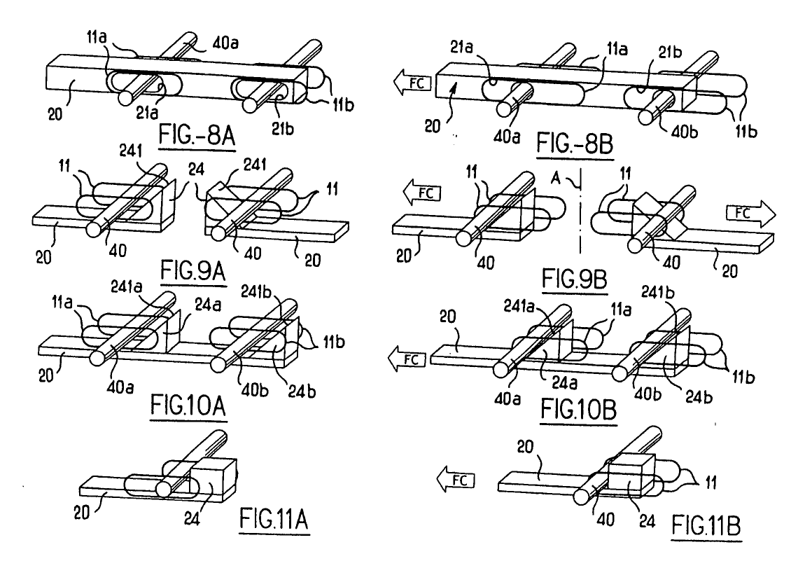

FIGS. 8A, 8B to 11A, 11B are simplified views showing only the locking member, the wire and the contours of a wire passageway of the head, in two different positions, illustrating a certain number of possible embodiments for the locking member,

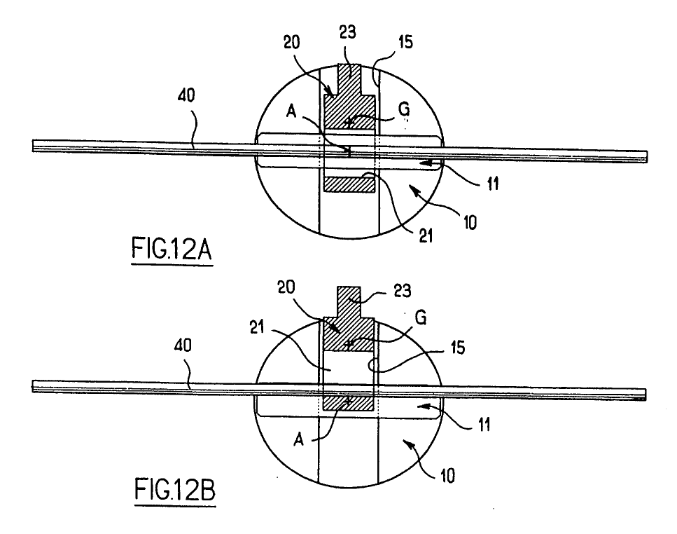

FIGS. 12A and 12B are views partially from above and partially in section of a head with a single cutting wire fitted with a locking device according to the invention, in two different positions,

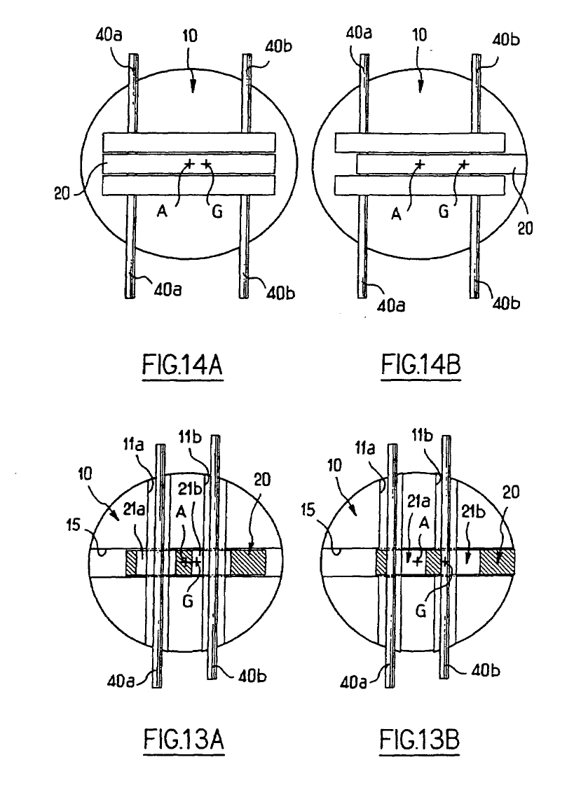

FIGS. 13A, 13B and 14A, 14B are respectively schematic views from above, in two positions, of two embodiments of the locking device for a head with two cutting wires,

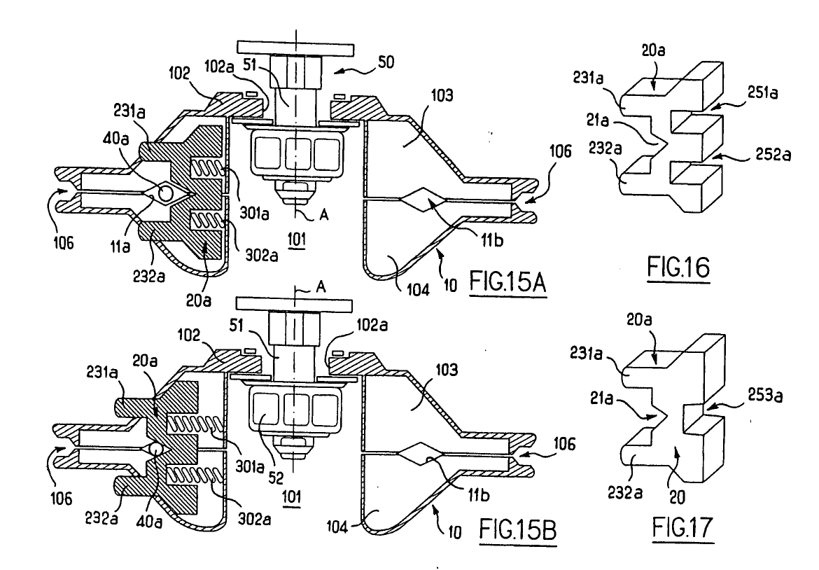

FIGS. 15A and 15B are views in axial section of a cutting head according to another embodiment of the invention,

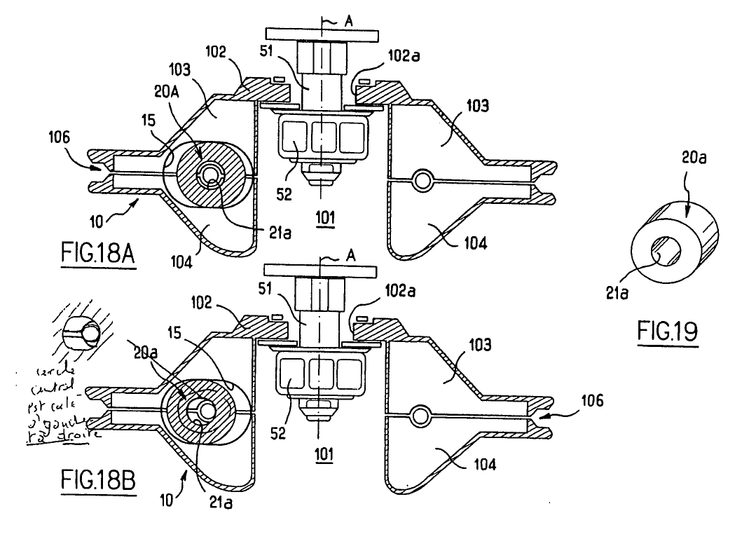

FIGS. 16 and 17 are views in perspective illustrating two possible embodiments for the locking member of the cutting head of FIGS. 15A and 15B,

FIGS. 18A and 18B are views in axial section of a cutting head according to yet another embodiment of the invention, and

FIG. 19 is a view in perspective illustrating the locking member of the cutting head of FIGS. 18A and 18B.

It will be noted as a preliminary that, from one figure to the next, identical or similar elements or portions have been indicated as far as possible by the same reference numbers, and will not be redescribed every time so as to prevent overcomplicating the description.

FIG. 1 and FIGS. 2A, 2B show the three components of a cutting wire locking device according to the invention that is (i) a sliding inertia block or slide 20, (ii) a region of the cutting head 10 having a passageway 11 for a cutting wire (not shown) and a guide 15 for the slide 20, extending substantially at right angles relative to the passageway 11, and (iii) an optional spring 30, here a helical compression spring.

The slide 20 has a transverse passageway 21 for the cutting wire, a collar 22 against which one end of the spring 30 placed around the slide can bear, and an actuation portion 23 accessible from the outside of the cutting head as will be seen in greater detail hereinafter.

In the present embodiment, the wire passageways 11, 21 formed respectively in the head and in the slide have one and the same circular cross section.

Although the whole of the cutting head has not been represented in FIGS. 2A and 2B, its axis of rotation A has nevertheless been shown.

FIGS. 3A and 3B correspond respectively to FIGS. 2A and 2B, with a cutting wire or filament 40 engaged in the device. The cutting wire here is a section of ordinary cutting wire, of circular cross section and with a diameter substantially smaller than that of the passageways 11 and 21.

In the position of FIGS. 2A and 3A, a pressure has been exerted by the user on the actuation portion 23, toward the right in the figure, so as to substantially align the passageways 11 and 21 while compressing the spring 30. In this alignment relation, the wire 40 has been able to be engaged in the passageways 11 and 21, as illustrated in FIG. 3A, while being positioned so that an appropriate length emerges from the cutting head, as will be illustrated hereinafter.

Once the pressure of the user is released, the assembly spontaneously adopts the position of FIG. 3B, in which the cutting wire 40 is firmly held in the device thanks to the shearing stress generated between the bearing of the wire 40 on the wire passageway 11 made in the cutting head, either side of the slide 20, and the bearing of the wire in the slide 20 on the wire passageway 21.

It is important to observe here that, preferably, the rotation of the cutting head about its axis of rotation A contributes to further acting on the slide 20 in the direction of the aforementioned shearing stress, so as to further accentuate the retention of the cutting wire when the cutting device is used.

In this case, the spring 30 may be omitted, or may act in a different direction, the retention pressure being provided only or mainly by the centrifugal force alone.

Naturally, the weight of the sliding inertia block 20 and, where appropriate, the force exerted by the spring 30, are chosen so that the shearing stress exerted on the wire to hold it does not culminate in severely gashing the latter or cutting it off and this is so even with the smallest cross sections of cutting wire that can be used.

It will be noted in FIGS. 3A and 3B that the passageways 11, 21 make it possible to accept cutting wires of extremely diverse sizes and shapes, so long as their cross section fits into the circular section of these passageways.

It has also been observed that the pressure exerted on the wire and allowing it to be locked in the cutting head is essentially independent of the size of the wire.

FIG. 4 illustrates schematically a cutting head 10 that is generally disk-shaped, in which two parallel wire passageways 11a, 11b have been arranged, passing through the head from one side to the other and preferably separated from one another by such a distance that the four wire outlets 111, 112, 113 and 114 are evenly distributed on the periphery of the head, with angular spacings of approximately 90°.

Each wire passageway has an oblong cross section with the large axis of this cross section situated in the plane of the head.

Each wire passageway 11 is associated with a locking device as described with reference to the preceding figures. The two slides 20a, 20b here extend in line with one another, on a diameter of the head, so as to be able to lock the cutting wire substantially in the middle of the respective wire passageway.

The wire passageways 21a, 21b formed in the respective slides 20a, 20b are preferably of an oblong cross section substantially identical to the cross section of the passageways 11a, 11b.

The actuation portion 23a, 23b of each slide may be used to push the latter inward until its wire passageway 21a, 21b is substantially aligned with the respective wire passageway 11 of the head, to allow a section of cutting wire 40a, 40b respectively to be inserted. The latter has a length that is chosen so that, when it is centered relative to the passageway 11, two substantially identical lengths of wire emerge from the head at the respective wire outlets. Thus, a single locking device makes it possible, according to an advantageous aspect of this embodiment, to simultaneously lock two lengths of cutting wire.

When the pressure on the actuation portion 23 is released, the spring 30 acts on the slide 20 to lock to a certain degree the respective section of cutting wire 40.

Then, when the device is used, the rotation of the cutting head generates on the slides 20 a centrifugal force which firmly holds the lengths of wire.

FIG. 5 illustrates in perspective a locking device with oblong passageways according to the invention, the cutting head here being materialized by only two regions of the latter running along the slide 20 and delimiting the passageway 15 in which the slide is guided. The slide 20 is here capable of simultaneously locking two sections of cutting wire 40a, 40b. Accordingly, the cutting head 10 has two wire passageways 11a and 11b and the slide 20 has two counterpart wire passageways 21a, 21b. The slide 20 is here plate-shaped, with a width such that two shearing stresses on each section of wire 40a, 40b are exerted at a mutual distance corresponding to the width of the slide.

FIGS. 6A and 6B illustrate a wire locking device similar to that of FIG. 5, but with a slide 20 of substantially lesser width. In FIG. 6A, the slide has been acted upon by the user to align the wire passageways of the head and of the slide, to allow the sections of wire 40a, 40b to be installed. In FIG. 6B, the slide 20 is acted upon by the centrifugal force FC and simultaneously locks the two sections of wire.

FIGS. 7A and 7B are similar views to FIGS. 6A, 6B, the difference lying in the flattened diamond shape of the cross section of the wire passageways 11a, 11b of the cutting head 10 and preferably, not shown, also of the wire passageways 21a, 21b of the slide 20.

This particular shape of the wire passageways has two advantages. The first is that by acting on two distinct regions of the surface of the wire when the shearing stress (corresponding to the two inclined faces in contact with the wire) is applied, the risks of cutting off the wire in the event of great centrifugal force are reduced. The second advantage is that, when the cutting wire has a polygonal cross section, for example square, and is designed to adopt an orientation such that the plants are attacked at a ridge of the wire, this cross section of wire passageways makes it possible to hold the wire in this orientation, or, in any case, helps to do so.

FIGS. 8A, 8B to 11A, 11B illustrate various principles of wire locking by shearing effect. In these figures, the wire passageways 11 or 11a, 11b formed in the cutting head are illustrated schematically by the contour of their cross section.

FIGS. 8A and 8B illustrate a principle already described above, with oblong wire passageways.

FIGS. 9A and 9B illustrate an embodiment in which the wire passageways 11 of the cutting head have an oblong cross section and in which the slide 20 has a working region 24 having a slope 241, for example at 450 relative to the direction of movement of said slide, the cutting wire 40 being locked by shearing stress between this slope and the semicylindrical-shaped end of the wire passageway 11 of the cutting head.

FIG. 9B illustrates the position of the axis of rotation A of the cutting head, and the direction of the centrifugal force FC exerted on the two slides 20, when the head rotates about this axis.

FIGS. 10A and 10B illustrate a principle identical to that of FIGS. 9A and 9B, but used in a dual locking device, with two wire passageways 11A, 11B in the head and two locking slopes 241a, 241b on the slide 20. The centrifugal force FC exerted on the slide 20 simultaneously locks two sections of wire 40a, 40b.

FIGS. 11A and 11B illustrate another embodiment, in which the working region 24 of the slide 20 has a straight working face, perpendicular to the direction of movement of the slide.

FIGS. 12A and 12B represent schematically a cutting head 10 provided with a wire passageway 11 disposed on a diameter.

The slide 20 moves in a guide 15 also formed on a diameter, perpendicular to the direction of the wire passageway 11. Here again, a single locking device provides the locking for two lengths of wire emerging respectively at the two ends of the passageway 11.

In order that the rotation of the cutting head produces a centrifugal force capable of acting on the slide 20 so that it effectively locks the wire 40, the masses of the slide are distributed so that its center of gravity G is situated in an offset manner relative to the axis of rotation A of the head.

Here again, the slide has an actuation portion 23 that can be actuated by the user to align the wire passageway 21 of the slide with the wire passageway 11 of the head 10.

FIGS. 13A and 13B illustrate an arrangement of a cutting head 10 with two wire passageways 11a, 11b parallel with one another, and a wire locking device for the two wires 40a, 40b engaged respectively in the two passageways. Here again, the center of gravity G of the inertia block formed by the slide 20 is offset relative to the axis of rotation A of the head, so that the rotation of the cutting head induces the movement of the slide 20 in the direction of a locking of the cutting wires.

FIGS. 14A and 14B illustrate a principle similar to that of FIGS. 13A and 13B. On the geometric plane, the slide 20 is centered relative to the axis of rotation A of the head. On the other hand, the masses of said slide are distributed so that its center of gravity, as in the preceding case, is offset relative to the axis of rotation A of the head.

Now with reference to FIGS. 15A and 15B, the structure of a cutting head produced according to the invention is represented in greater detail. It comprises two plates 103, 104 with circular contours assembled together for example with screws (in a manner not shown).

The plate 103 comprises a top flange 102 in which an axial passageway 102a is formed for the shaft 51 with a threaded end of the plant cutting device. A nut 52 screwed onto the shaft 51 through a central cavity 101 defined by the plates 103, 104 makes it possible to immobilize the cutting head on the shaft, in a conventional manner per se.

Two parallel passageways 11a, 11b for two sections of cutting wires are formed by complementary recesses formed in the opposite faces of the two plates 103, 104, these passageways here having the shape of flat diamonds.

The two plates 103, 104 also define jointly a peripheral groove 106 in which the emerging lengths of cutting wire may rest and, if necessary, be guided and held in their orientation appropriate for cutting.

The shearing stress capable of causing the lengths of cutting wire to be locked is generated by two slides 20a, 20b, only one of which is visible in FIGS. 15A and 15B and represented in greater detail in FIG. 16.

It comprises two cavities 251a, 252a capable of receiving respectively two compression springs 301a, 302a bearing on an inner wall of the head, respectively at the level of the plates 103 and 104 and a V-shaped recess 21a capable of acting on the cutting wire 40a while engaging in a guide channel (not visible) intersecting the passageway 11a for this cutting wire.

The slide 20a furthermore comprises two fingers 231a, 232a protruding outside the cutting head at the level of conical faces belonging to the respective plates 103, 104, so as to allow the user to act on the slide 20a to make it possible to install the respective section of cutting wire (FIG. 15A). It will be noted here that, in this manner, the actuation fingers are, in a radial direction, set back from the periphery of the cutting head, so as not to be exposed to the extremely high stresses exerted by the plants when the device is working.

In the position of FIG. 15B, the slide 20a has been released and, under the effect of the centrifugal force and, by the way, of the springs 301a, 302a, the portion 21a of the latter in cooperation with the walls of the wire passageway 11a exerts on the wire a shearing action to firmly hold the latter in the cutting head 10.

The slide 20b is formed, disposed and actuated symmetrically with the slide 20a relative to the axis of rotation A of the head.

FIG. 17 of the drawings illustrates a variant embodiment of the slide 20a, in which the latter is acted on not by two springs but by a single spring disposed in a cavity 253a formed at mid-height.

FIGS. 18A and 18B illustrate an embodiment that differs from those of FIGS. 15A and 15B mainly by the shape of the wire passageways 11a, 11b and of the respective locking slides 20a, 20b. Thus each wire passageway 11a, 11b has a circular cross section, being formed by two semicircular recesses formed in the plates 103, 104 of the head.

The slides 20a, 20b (of which only the slide 20a is shown) have the shape of rings. Thus the slide 20a has (see also FIG. 19) with a central passageway 21a of circular cross section for the cutting wire and a coaxial cylindrical peripheral surface, by which the slide is guided in its oblong-profile channel 15, whose height is substantially equal to the diameter of the slide.

In the position of FIG. 18A, the slide 20a occupies a position in which the cutting wire 40a can be installed in its passageway 10a. In the position of FIG. 18B, the slide 20a is acted upon radially outward under the effect of the centrifugal force, to firmly lock the section of wire 40a in the cutting head.

The slide 20b is formed, positioned and actuated symmetrically with the slide 20a relative to the axis of rotation A of the cutting head 10.

Naturally, the present invention is not restricted to the embodiments described and represented, and those skilled in the art will be able to apply numerous variants and modifications thereto. In particular, the wire locking device according to the invention, although it has been described in its application to individual strands of wire, may equally apply to the locking of a wire paid out from a reel of wire received in the head.

In addition, it is understood that the various aspects of the novel cutting head described in the foregoing may, in certain cases, be used independently of one another or else combined in various manners.

1-21. (canceled)

22. A cutting head for a brush-cutter, edge-trimmer or similar, comprising a passageway for a cutting wire and a movable element for locking the wire, wherein the locking element comprises a slide which is capable of moving linearly in a guide that intersects the wire passageway and which is subjected to a force, the slide and the wire passageway in the vicinity of the guide having working surfaces capable of locking the wire by shearing effect.

23. The cutting head of claim 22, wherein said force is a centrifugal force generated by the rotation of the head.

24. The cutting head of claim 23, wherein the slide is acted upon by a spring.

25. The cutting head of claim 24, wherein the spring acts in the same direction as the centrifugal force.

26. The cutting head of claim 25, comprising two passageways for two sections of cutting wire.

27. The cutting head of claim 22, wherein the wire passageway or each wire passageway opens onto the outside of the head at its two ends, so as to receive a section of cutting wire whose two terminal lengths operate.

28. The cutting head of claim 26, comprising a common slide capable of locking the two sections of cutting wire.

29. The cutting head of claim 28, comprising two slides capable of locking respectively the two sections of wire.

30. The cutting head of claim 29, wherein the two slides are capable of moving in opposite directions along a diameter of the head.

31. The cutting head of claim 26, wherein the two wire passageways are parallel with one another.

32. The cutting head of claim 31, wherein the two ends of the two wire passageways define four wire outlets mutually spaced by approximately 90° in the peripheral direction of the head.

33. The cutting head of claim 22, wherein the cross section of the wire passageway or of each wire passageway is chosen from the circular, oblong or polygonal shapes.

34. The cutting head of claim 33, wherein the cross section of the wire passageway or of each wire passageway has a flattened diamond shape.

35. The cutting head of claim 22, wherein the working surface of the slide belongs to a through wire passageway formed in the slide.

36. The cutting head of claim 35, wherein the through wire passageway formed in the slide has the same cross section as the corresponding wire passageway formed in the cutting head.

37. The cutting head of claim 35, wherein the through wire passageway formed in the slide has a cross section different from that of the corresponding wire passageway formed in the cutting head.

38. The cutting head of claim 22, wherein the working surface of the slide is formed on a profiled working region.

39. The cutting head of claim 38, wherein the working surface of the slide is oriented obliquely relative to the direction of movement of the slide.

40. The cutting head of claim 22, wherein the slide or each slide comprises an actuation portion that can be accessed from the outside of the head and that makes it possible to position the said slide so that it does not form an obstacle to the engagement of a section of cutting wire in the corresponding wire passageway formed in the head.

41. The cutting head of claim 40, wherein said actuation portion is, in the radial direction, set back relative to the periphery of the cutting head.

42. A cutting device such as a brush-cutter, edge-trimmer or similar, comprising a motor capable of rotating a cutting head comprising a passageway for a cutting wire and a movable element for locking the wire, in which the locking element comprises a slide which is capable of moving linearly in a guide that intersects the wire passageway and which is subjected to a force, the slide and the wire passageway in the vicinity of the guide having working surfaces capable of locking the wire by shearing effect.
